(19) United States
(12) Patent Application Publication
(10) Pub. No.: US 2017/0373498 A1
(43) Pub. Date: Dec. 28, 2017

(54) DISTRIBUTION OF ELECTRIC ENERGY ON A VESSEL

(71) Applicant: Siemens Aktiengesellschaft, Munich (DE)

(72) Inventors: Espen Haugan, Trondheim (NO); Harald Kjesbu, Hell (NO)

(73) Assignee: Siemens Aktiengesellschaft, Munich (DE)

(21) Appl. No.: 15/544,609

(22) PCT Filed: Jan. 22, 2016
(86) PCT No.: PCT/EP2016/051333

§ 371 Date: Jul. 19, 2017

(30) Foreign Application Priority Data
Jan. 23, 2015 (EP) 15152358.6

(51) Int. Cl. H02J 3/00; H02H 3/087; H02H 3/32; H02H 7/26

(52) U.S. Cl. CPC H02J 3/006; H02H 7/268; H02H 3/087; H02H 3/325

(57) ABSTRACT

A stored electric energy distribution arrangement for distribution of stored electric energy on a vessel having one or more AC consumers, in the event of failure of a primary electric energy supply to the AC consumers has a DC-circuit. The DC circuit has a plurality of backup electric energy storage elements connected in a ring, for supplying stored electric energy to one or more AC consumers in the event of failure of the primary electric energy supply. A plurality of breaker systems are provided in the DC circuit for disconnecting one or more backup electric energy storage elements from the DC-circuit, in the event of a fault associated with that backup element.

### CROSS REFERENCE TO RELATED APPLICATIONS

This application is the US National Stage of International Application No. PCT/EP2016/051333 filed Jan. 22, 2016, and claims the benefit thereof. The International application claims the benefit of European Application No. EP15152358 filed Jan. 23, 2015. All of the applications are incorporated by reference herein in their entirety.

### FIELD OF INVENTION

The present invention relates to an arrangement for distribution of stored electric energy on a vessel, including a ship or platform and to a method of operating an arrangement for distribution of electric energy on a vessel.

### BACKGROUND OF INVENTION

For operating a vessel, in particular a ship or a platform, e.g. oil exploration platform, electric energy may need to be distributed to a number of consumers, such as thrusters and pumps, which may need to be operated on a vessel. The vessel or platform may comprise essential components that need to be supplied with electric energy even in the case of a failure of some part of the energy distribution system. In case of a failure, a backup energy storage system may be required, to provide the electric energy that is unavailable due to a failure.

Conventionally, a vessel may have a number of thrusters which are essential for operation, a typical number being four or eight thrusters. In order to operate the vessel properly and in particular to maintain the position of the vessel in the water, these thrusters must remain operational. For each of the essential thrusters, a particular backup energy storage system may be provided which may supply the thruster with electric energy in case of a failure, for example a failure in a main energy supply grid. Therefore, the individual energy storage backup systems may be required to have a relatively high capacity and may therefore be relatively large in size, costly and complex.

Thus, there may be a need for an arrangement for distribution of electric energy on a vessel and for a method for operating an arrangement for distribution of electric energy on a vessel, where a reliable energy backup system is achieved that requires less complex equipment and less voluminous and costly equipment, whilst at the same time ensuring a reliable and safe supply of electric energy to essential components of the vessel in case of a failure in either a main energy distribution grid or some sub-components within the energy distribution grid.

### SUMMARY OF INVENTION

This need may be met by the subject matter according to the independent claims. Advantageous embodiments of the present invention are described by the dependent claims.

In accordance with a first aspect of the present invention a stored electric energy distribution arrangement for distribution of stored electric energy on a vessel comprises one or more AC consumers, in the event of failure, or insufficiency, of a primary electric energy supply to the AC consumers, the arrangement comprising a DC-circuit comprising a plurality of backup electric energy storage elements connected in a ring, for supplying stored electric energy to one or more AC consumers in the event of failure of the primary electric energy supply; and a plurality of breaker systems in the DC circuit for disconnecting one or more backup electric energy storage elements from the DC-circuit, in the event of a fault associated with that backup element.

The primary electric energy supply may comprise an AC main grid.

The DC circuit supplies stored energy to the AC consumers if the AC supply fails, or is insufficient for the requirement, but is able to disconnect faulty elements in the DC circuit to avoid interfering with the main power grid if a fault occurs in the backup system.

The arrangement for distribution of electric energy may also comprise components for generating the electric energy, such as diesel generators or gas turbine generators. The vessel may be operated on the sea and may for example comprise a platform or a ship. The DC-circuit may be operated for example between 500 V and 1000 V, in particular at around 930 V DC. Thereby, the voltage may be appropriate to power conventional consumers, in particular conventional AC-consumers which may be connected, via inverters to the DC-circuit. The DC-circuit may comprise a number of sections of high power cables. The DC-circuit may comprise several sections of DC-bars (DC bus bars).

The backup element(s) may be provided to supply essential elements, in particular essential consumers, such as thrusters, with electric energy in case of a failure in a main energy grid, which may supply electric energy to these plural consumers during normal operation. The backup elements may directly feed electric energy into the DC-circuit. Essentially, the backup elements may provide a DC power stream to the DC-circuit in case of a failure. Under normal conditions, the plural backup elements may be loaded or charged from a main grid via the DC-circuit. The plural backup elements are connected, via the plural breaker systems, to form a ring. Each one of the plural backup elements may, individually or in combination with other backup elements, be disconnected from the DC-circuit, in order to remove them from the ring. Thus, in case of a potential failure in one of the backup elements, the backup element having the failure may be disconnected from the DC-circuit, in a fast and reliable manner. This enables continued operation of the other backup elements, either to provide electric energy to consumers of the vessel, or to allow the backup elements to be charged or loaded, when the main energy grid is operating normally.

There are several advantages to having, the plurality of backup elements connected to each other in a ring in normal operation. In particular, different consumers installed in the vessel, such as different thrusters, may require different amounts of power during operation of the vessel. Since, in the arrangement according to embodiments of the present invention, a particular backup element is not associated with one particular consumer exclusively, the backup elements may be able to have a lower energy supply capacity compared to conventional systems. This may be because energy output of the plurality of backup elements may be shared and combined and be used to supply to any, or all, of the different consumers. In particular, supplying to a specific consumer energy only from a specific associated backup element avoids the need for a particular backup element to be designed to supply sufficient power to a particular consumer. The combined power output of all the backup elements can be chosen such that the combined power demand of all consumers may be satisfied. Thereby, space and complexity and capacity of the plurality of backup elements may be reduced compared to conventional systems.

In conventional systems, by contrast, connecting several backup elements together is generally avoided, since it may not have been possible to disconnect a failed backup element from the other backup elements sufficiently quickly, when a failure in one of the backup elements occurred. However, the plural breaker systems employed in embodiments according to the present invention may in a fast manner to disconnect a particular backup element in case of a failure, thereby limiting a failure current. For example to less than 10 kA.

The energy storage in the ring configuration may not interfere with the main power grid that may supply electric energy (in the form of an AC power stream) to the DC-circuit under normal conditions. Furthermore, rectifier diodes between the AC main power grid and the DC-circuit block flow of power back to the main power grid. The ring configuration of the DC-circuit may be split up or divided with very fast power electronic switches (in the breaker systems) which disconnect a failed backup element or other element within a few microseconds, typically 10 to 20 μs. Due to a very fast disconnection of failures, the failures may only interfere with one island or one of the backup elements.

Thus, physical location of the battery or backup elements or energy storage may be within the same fire zone as the different thrusters.

According to an embodiment of the present invention, at least one breaker system comprises two breaker units connected on each side of a backup element connected within the (ring of the) DC-circuit. Having two breaker units (also called switches) for each breaker system may enable disconnection of a failed backup element on only one side, or the other, or on both sides at the same time. Thus, more flexible disconnection of a failed part or component may be provided. A failure may for example be a fire taking place in a particular fire zone. Having two breaker units, one in each fire zone, may make it possible to have a single fault or failure without blackout ensuring high security for the rig or the vessel.

According to an embodiment of the present invention, the breaker unit is adapted to disrupt, or break, a connection to the DC-circuit upon detection of a failure in a time of between 5 μs and 500 μs, or between 10 μs and 100 μs, or between 10 μs and 20 μs.

Thus, the breaker unit is adapted to disrupt a connection to the DC-circuit in a very short time so as to avoid increase of the current to unacceptable values, such as above 10 kA. Thereby, a reliable and safe operation of the backup element(s) and the entire distribution arrangement may be achieved.

According to an embodiment of the present invention, the breaker unit is adapted to detect a failure by measurement of current and/or voltage on each side. The measurement may be at a frequency of between 50 kHz and 500 kHz, or between 150 kHz and 250 kHz.

The breaker unit may comprise one or more sensors and an electronic controller which operates the sensor and acquires measurement signals. Thus, the breaker unit may operate autonomously, in an independent manner. The breaker unit may be programmed in order to set the threshold value above which the breaker unit may disconnect or disrupt the connection within the ring. Thus, no additional measurement or control equipment may be required to operate the arrangement.

According to an embodiment of the present invention, the breaker unit is adapted to disrupt, or break, a connection to the DC-circuit, if the current measured on at least one side is larger than a current threshold and/or if a voltage difference measured on the two sides is larger than a voltage difference threshold.

The breaker unit may comprise an electronic unit or processor with arithmetic/logical functionality. Further, the breaker unit may comprise two power transistors, such as two IGBTs, which are connected in series and which may be supplied with appropriate control signals in order to perform switching, i.e. connecting or disconnecting the particular backup element to the ring or from the ring. The controller of the breaker unit may be adapted to generate gate driver signals, such as pulse width modulation signals, to perform the switching of the two power transistors. The breaker unit may be programmable, for example regarding the values of the current threshold and/or the voltage difference threshold. Due to the high switching speed, any interference of a failure in one of the backup elements with other backup elements or the main energy grid may be reduced or even avoided.

According to an exemplary embodiment of the present invention, each of the backup elements comprises an energy storage unit, such as a battery, for storing electric energy for use in a failure situation.

The energy storage unit may provide electric energy to essential consumers of the vessel in case of a failure, for example in the main energy grid or short circuit in the battery. The energy storage may be charged or loaded during normal operation. Thereby, operation of the vessel may be maintained even in the case of a failure in the main grid or in one of the backup elements.

For setting the arrangement for distribution of electric energy in a normal operation state or a failure state, plural switches may be provided between different components of the arrangement. At least the switches between the backup elements may be configured as breaker units having very fast switching speeds, as has been explained above. Other switches may also comprise mechanical switches which have much lower switching speeds, such as switching speeds which are 10 times less than the switching speed of the breaker units between the backup elements.

According to an embodiment of the present invention, the energy storage unit is connected to the DC-circuit via a DC-DC-converter adapted to control input and output current and/or input and output voltage, using pulse width modulation.

The DC-DC-converter may ensure that the energy storage unit may be charged during normal operation with an appropriate current and voltage. Furthermore, in a failure situation, the DC-DC-converter may also control voltage and current during discharge of the storage element, avoiding damage to the energy storage unit and ensuring the appropriate current and voltage is provided for the consumers in the failure situation.

According to an embodiment of the present invention, an AC-consumer is connectable, to the DC-circuit via an inverter system. The AC consumer may comprise one or more of a variable speed drive, a thruster or auxiliary equipment.

The inverter system may invert the DC power stream to an AC power stream or a power stream comprising a square or rectangular signal having adjustable duty cycle and frequency. In particular, a thruster may be operated at a desired frequency and the inverter system may be adapted to provide the power stream having the desired frequency, such as a harmonic power stream or a rectangular or square-like wave.

In this way, different thrusters of the vessel may for example be operated at different frequencies or rotation speeds, so as to ensure positioning of the vessel as desired.

According to an embodiment of the present invention, at least one thruster receives energy from the DC-circuit via four inverters of the inverter system. Providing four power streams for the consumers may support conventional consumers, such as thrusters in an advantageous manner. Other numbers of inverters may be possible.

According to an embodiment of the present invention, the arrangement further comprises an AC-bar, having plural generators connected thereto. The AC-bar may be connectable to at least one other AC-bar to form an AC-ring.

The AC-bar may also be referred to as the main power grid or main grid. The generators may for example be diesel generators or gas turbine generators. One or more AC-bars may be releasably connectable to each other to form a ring. In case of failure in one of the AC-bars, the failed AC-bar may be disconnected from the other AC-bars. Each of the other AC-bars may have an associated other DC-circuit connected thereto which in turn is connected or connectable to other consumers, in particular other AC-consumers, via other inverters and transformers and also has other backup elements connected in a ring of the other DC-circuit(s).

If one of the AC-bars fails, the associated backup elements may provide substitute electric energy to essential consumers. Thus, a high reliability of the energy distribution may be achieved.

According to an embodiment of the present invention, the AC-bar, is connectable to at least one of the backup elements via a transformer, a diode and a rectifier system, wherein the diode is adapted to block an energy stream from the DC-circuit to the AC-bar. The AC-bar may operate at a voltage between 5 kV and 15 kV. The transformer may transform to a voltage between 500 V and 1000 V.

The transformer may transform the voltage at the main grid to a voltage which is appropriate for typical consumers. The diode may block a flow of energy back from the backup element to the main grid. The rectifier system may rectify the AC-voltage at the main grid to a DC-voltage which is then provided at the DC-circuit. This enables electric energy at the appropriate voltage to be supplied to a plurality of consumers.

According to an embodiment of the present invention, the transformer has one set of primary windings and two sets of secondary windings (inductively coupled to the set of primary windings), wherein the rectifier system comprises two rectifiers connected to the two sets of secondary windings of the transformer. This configuration of a transformer has been proven to be advantageous due to an appropriate phase-shift between the phases of the two secondary power streams.

Other transformers are possible. For example, a transformer may only have one set of primary windings and one set of secondary windings.

According to an embodiment of the present invention, the transformer and the rectifier system are separated from the backup element and housed in different casings.

Depending on the application, this configuration may be advantageous. In particular, the transformer and the rectifier system may be housed in a common housing and the backup element (potentially with a DC-AC-inverter and an auxiliary consumer transformer) may be housed in another casing.

According to an alternative embodiment of the present invention, the transformer, is housed together with the backup element in one casing. The rectifier system may be housed with the backup element in one casing. The module may be sold as a switchboard and may be assembled in a desired system.

It should be understood that features which are individually or in any combination provided, explained or employed for an arrangement for distribution of electric energy on a vessel may also be provided or used in a method for operating an arrangement for distribution of electric energy on a vessel according to an embodiment of the present invention and vice versa.

According to a second embodiment of the present invention a method for operating a stored electric energy distribution arrangement for distribution of electric energy on a vessel comprises detecting a failure in a DC-circuit having a plurality of backup electrical energy storage elements connected in a ring for supplying stored electrical energy to one or more AC consumers in the event of failure of the primary electric energy supply; and disconnecting one of the backup elements from the DC-circuit using a plurality of breaker systems, in the event of a fault associated with that backup element.

The method may be performed by an arrangement for energy distribution as is mentioned in some of the previous embodiments.

Embodiments of the present invention are now described with reference to the accompanying drawings. The invention is not restricted or limited to the illustrated or described embodiments.

Embodiments of the invention have been described with reference to different subject matter. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject matter, any combination of features relating to different subject matter, in particular between features of the method type claims and features of the apparatus type claims is considered to be disclosed by this document too.

### BRIEF DESCRIPTION OF THE DRAWINGS

Examples of an arrangement and method according to the present invention will now be described with reference to the accompanying drawings in which:

FIGS. 1a to 1d schematically illustrate a circuit diagram of an arrangement for distribution of electric energy according to an embodiment of the present invention; and

FIGS. 2a to 2d schematically illustrate a circuit diagram of an arrangement for distribution of electric energy according to another embodiment of the present invention.

### DETAILED DESCRIPTION OF INVENTION

The illustration in the drawings is in schematic form. It is noted that in different figures, similar or identical elements are provided with the same reference signs or with reference signs, which are different from the corresponding reference signs only within the first digit.

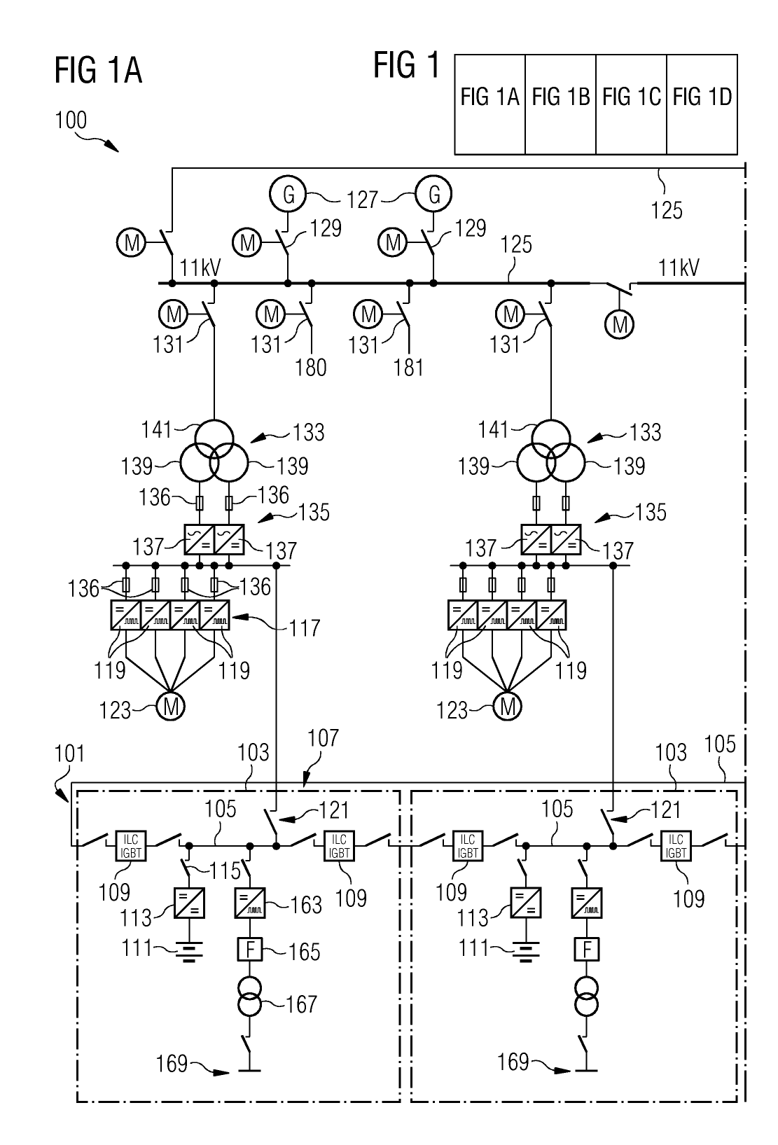

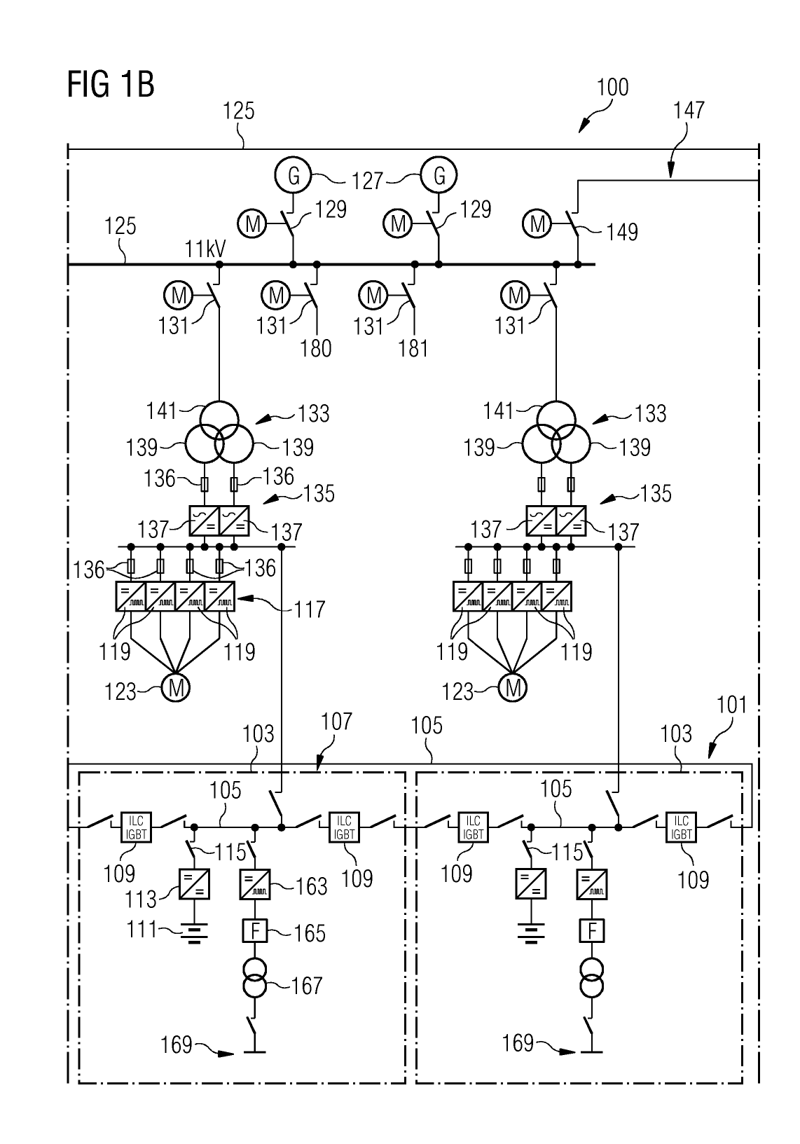

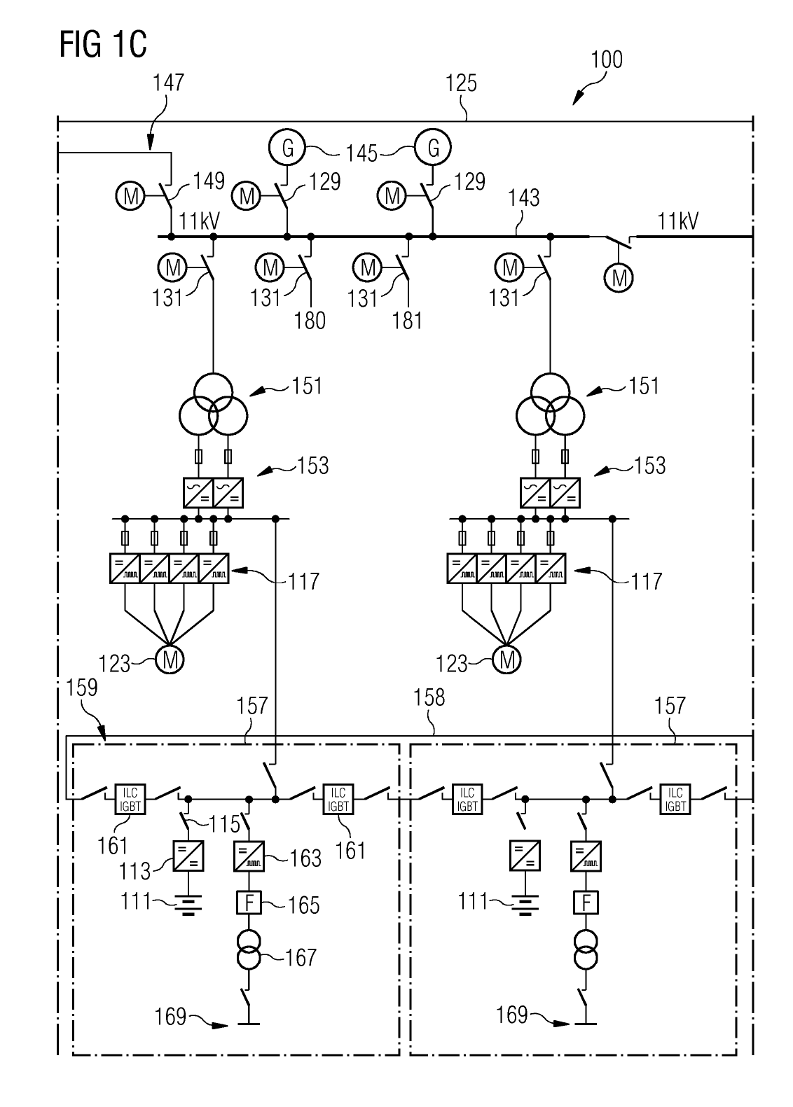

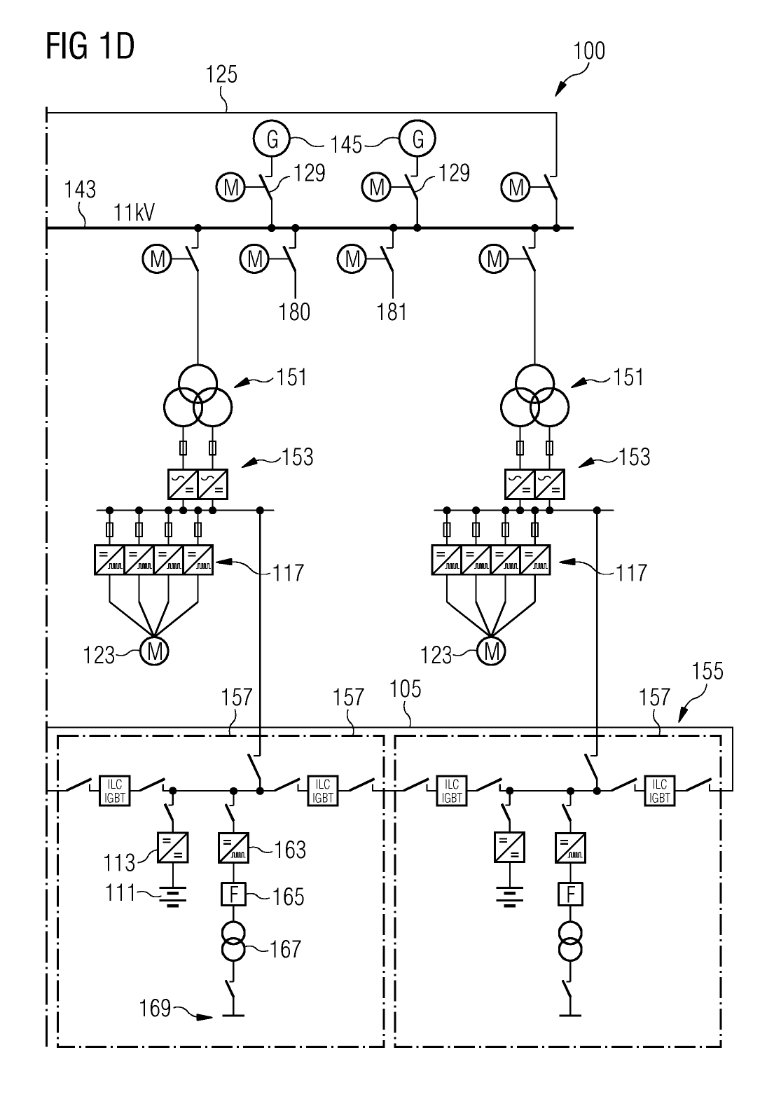

The arrangement 100 for distribution of electric energy on a vessel illustrated in FIGS. 1a to 1d comprises a DC-circuit 101 having a plurality of backup elements 103 (assembled in a similar or the same way and having similar or the same components) connected in a ring, formed by cable sections or bar sections 105. The backup elements 103 are connected in a ring during normal operation. Each backup element comprises a breaker system 107 comprising two breaker units 109 on each side of each backup element 103. Each breaker unit 109 comprises two power transistors connected in series such that each breaker system is adapted to disrupt a connection from a backup element to the DC-circuit 101 within a few microseconds. In this example, the breaker units are ILC insulated gate bipolar transistor (IGBT) breakers, but other suitably fast breakers may be used. The disconnection may for example occur in the event of a failure. For detection of such a failure, each breaker unit 109 comprises measurement sensors and control logic that disconnects or disrupts a connection if, for example, a measured current is above a current threshold and/or a measured voltage difference between the two sides is above a voltage threshold. The voltage and/or current may be measured at a rate of between 150 kHz and 250 kHz.

The backup element 103 further comprises an energy storage unit 111, such as a battery or an accumulator. The energy storage unit 111 is connected to the DC-circuit 101 or a cable section 105 via a DC-DC-converter 113 and a further switch 115. For the example shown, the energy storage unit is able to provide 1.25 MW for up to 60 minutes, but other storage capacities may be chosen according to the requirement.

Via an inverter system 117 comprising four inverters 119, the DC-circuit 101 is connectable, via a switch 121, to an AC-consumer 123. I the example illustrated the AC consumer is an essential thruster 123, rated at 5.5 MW, but the actual type of consumer and its rating depend upon the application. For this example, the vessel being supplied with electric energy by the arrangement 100 comprises eight thrusters 123, in order to properly position the vessel on the sea, shown as two aft port thrusters and two forward port thrusters 123 in FIGS. 1a and 1b and two aft starboard thrusters and two forward starboard thrusters 123 in FIGS. 1c and 1d. More or fewer thrusters may be provided.

The arrangement 100 further comprises an AC-bar 125 (AC bus bar) that has a plurality of generators 127 connected or connectable thereto, in particular via switches 129. Via further switches 131, the AC-bar 125 is connectable to the DC-circuit 101 (and thus to the backup elements 103) via a transformer 133 which for example transforms an 11 kV AC power stream to a DC-voltage between 500 V and 1000 V, in particular about 930 V. Switches 131 also allow the AC-bar to be connected to a utility transformer 170, or drilling transformer 171.

The down transformed voltage is further rectified by a rectifier system 135 connected between the transformer and the DC-bar 105, i.e. the DC-circuit 101. Furthermore, a diode 136 is connected between the transformer 133 and the rectifier system 135, in order to block energy flow from the DC-circuit 101 to the AC-bar 125.

In particular, the rectifier system 135 comprises two rectifiers 137 which are connected to two secondary windings 139 of the transformer 133 having one primary winding 141 inductively coupled to the two secondary windings 139.

The backup element 103 further comprises a consumer inverter 163 connected to the DC-circuit 101 and providing an AC power stream via a filter element 165 and a consumer transformer 167 to an auxiliary consumer 169, such as a pump for a bearing or the like, or thruster auxiliary. In this example, the consumer is rated at 690V, but the rating depends upon the specific consumer.

As is illustrated in FIGS. 1c and 1d, the arrangement 100 further comprises another AC-bar 143 having further generators 145 connected thereto in a similar manner as for those connected to the AC-bar 125. Via a connection system 147 comprising switches 149, the AC-bar 125 may be connected with the other AC-bar 143. Similarly, the other AC-bar 143 may be connected, via other transformers 151 and another inverter system 153 to another DC-circuit 155 comprising other cable sections or DC-bars 158. Other backup systems 157, constructed as the backup systems 103, are connectable in a ring configuration to the other DC-circuit 155. Other breaker systems 159 each comprising two breaker units 161 are provided in the other backup elements 157, in order to disrupt a connection from the backup unit 157 to the other DC-circuit 155 in case of a failure, for example failure of an adjacent or another further backup element 157 in the DC-circuit 155 configured in a ring.

Features in the two sections of the arrangement 100 of FIG. 1 which are similar in structure and/or function are labeled with the same reference signs.

In the present invention, an arrangement for distribution of stored electric energy on a vessel is such that there is flow of energy from an AC bar main grid to an AC consumer in normal operation; and, there is flow of energy from a DC bar to the AC consumer, in the event of failure of the AC main grid, or failure of sub-components of the AC consumer. This failure may be addressed by a DC-circuit having a plurality of backup elements connected in a ring; and a plurality of breaker systems for disconnecting a particular backup element from the DC-circuit.

During normal operation, the generators 127 may generate electric energy which may flow via the AC-bar 125, the transformer 133, the rectifier system 135 and the inverter system 117 to the thrusters 123. Further, the energy from the generators 127 may flow via the transformer 133 and the rectifier 135 to the backup elements 103 and within the backup elements 103 via the DC-DC-converter 113 to the energy storage unit or battery 111 for charging the battery 111 under normal conditions.

In case of a failure in the AC-bar 125 (also called main grid), the switches 131 may be opened and the thrusters 123 may be powered from energy stored in the battery 111 which flows via the DC-DC-converter 113 and the inverter system 117 to the thrusters 123.

In case of a failure in one of the backup elements 103, the breaker system 107 comprising the breaker units 109 may disconnect the failed backup unit 103 from the DC-circuit 101 such that the failed backup system 103 does not interfere with the operation of the other backup systems 103.

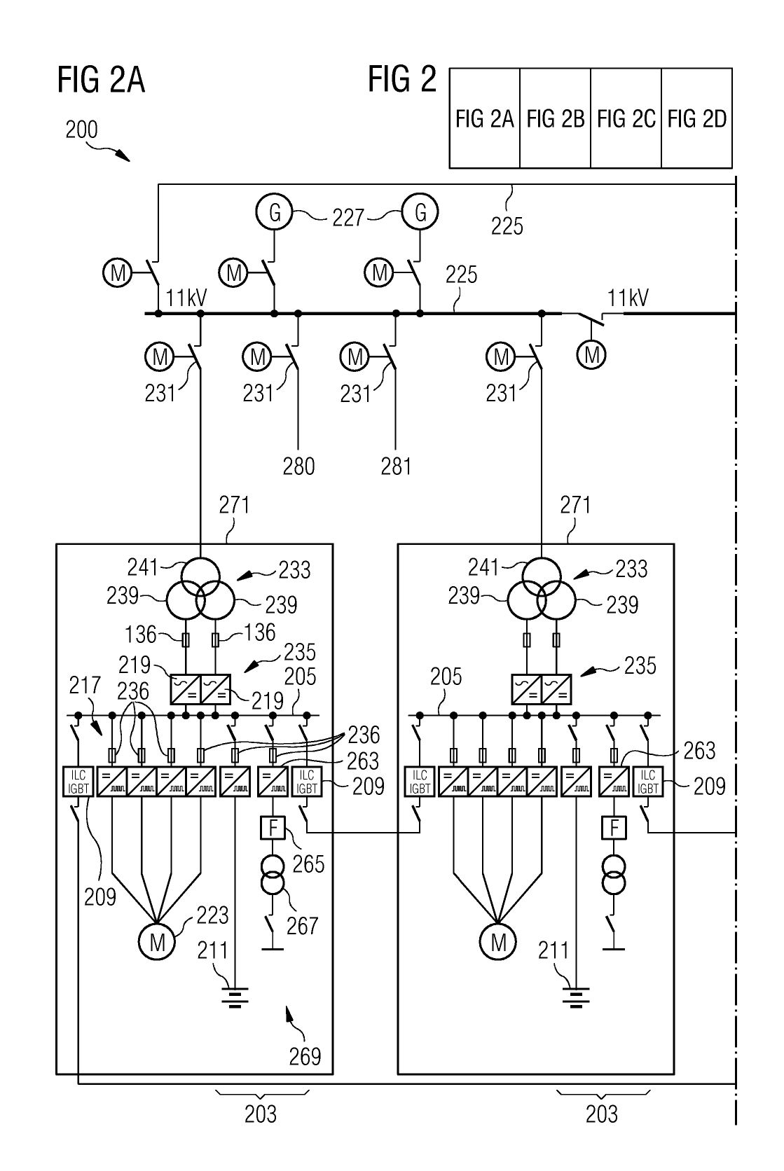

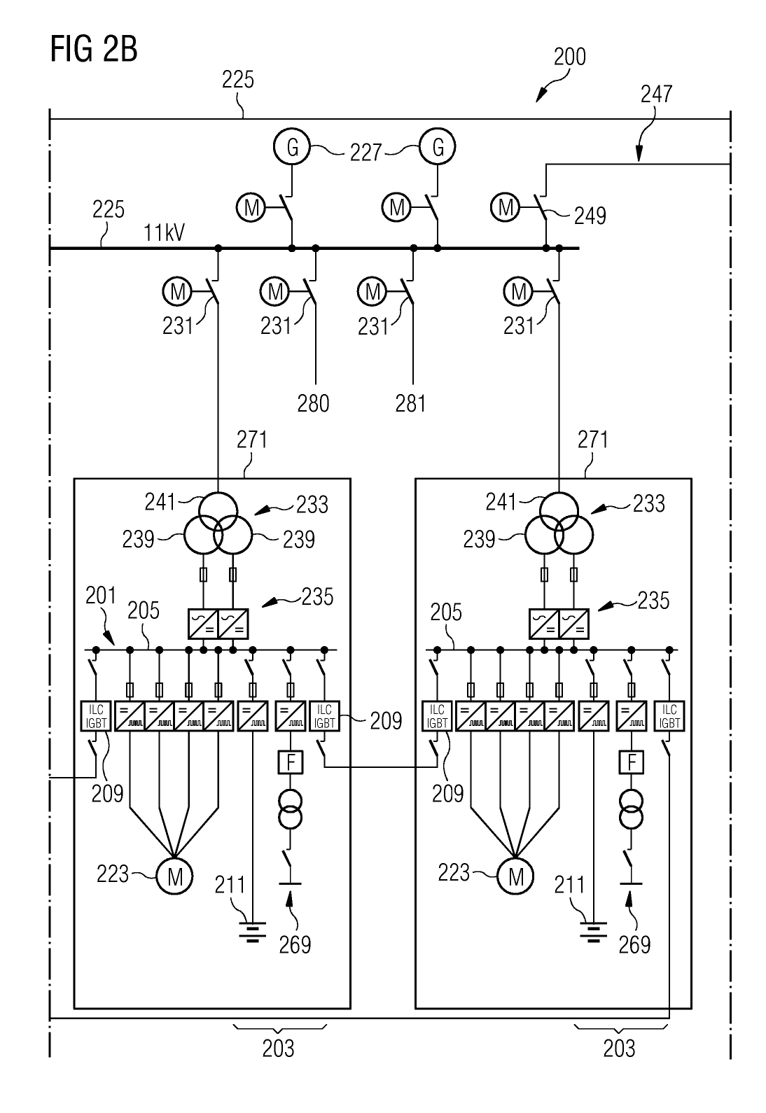

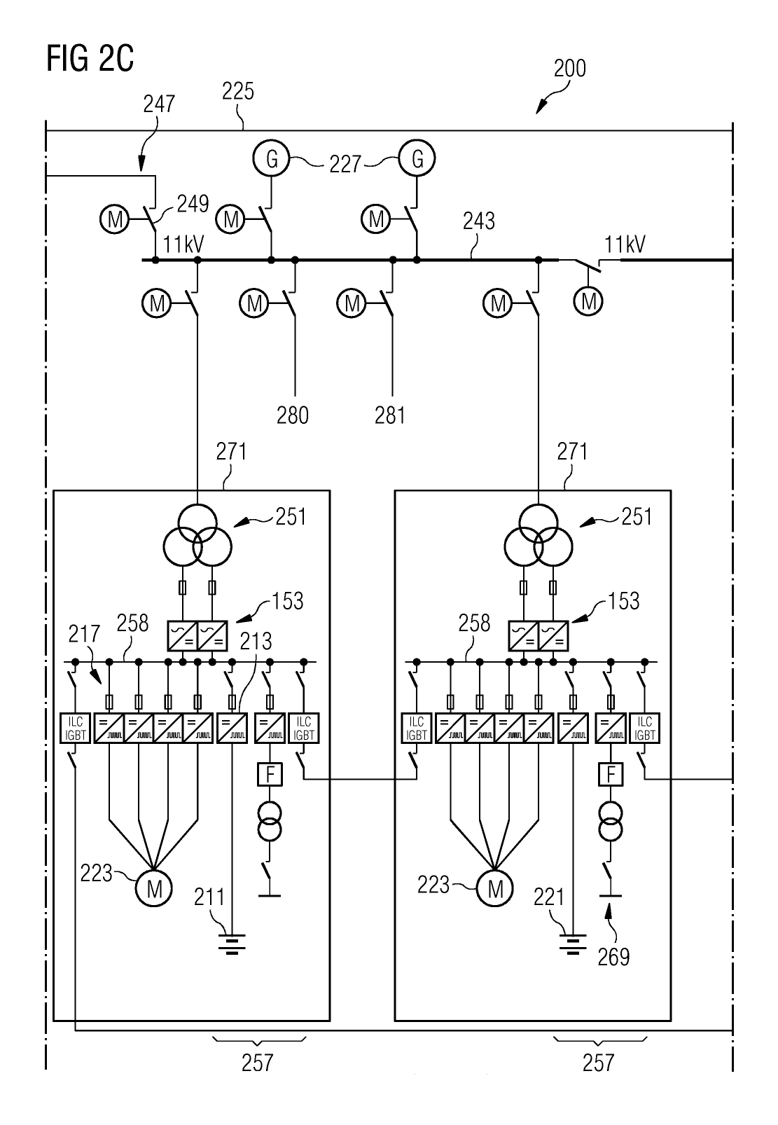

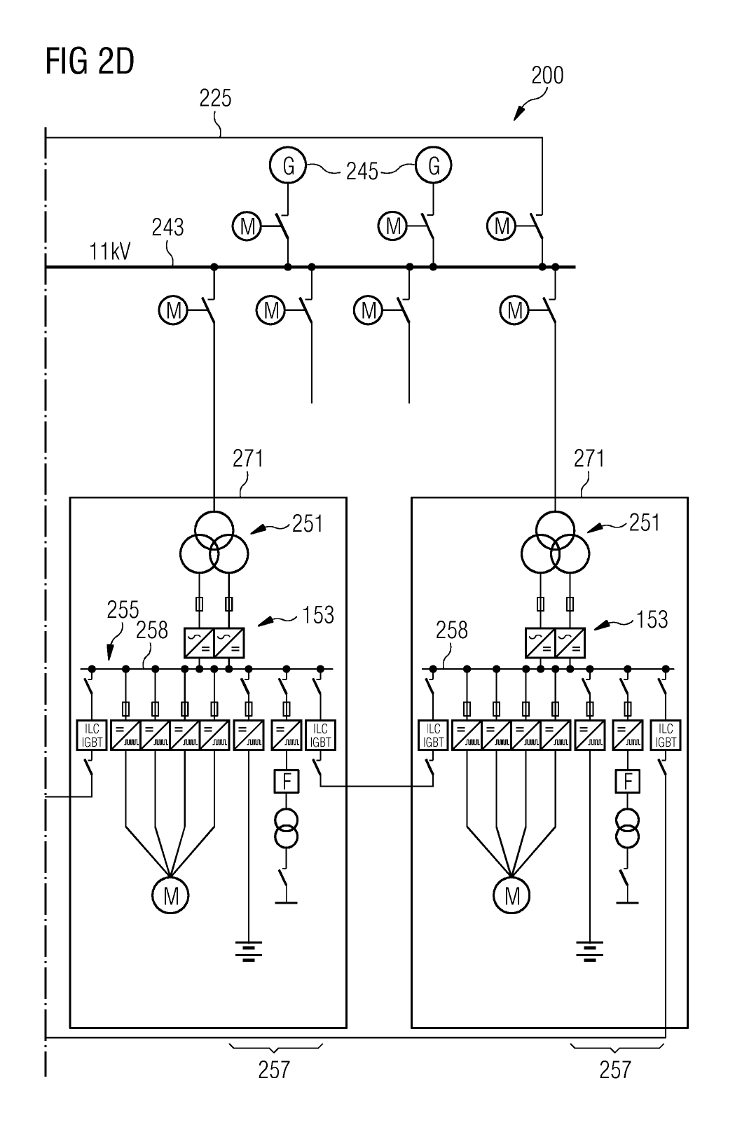

FIG. 2 schematically illustrates a circuit diagram of another arrangement 200 for distributing electrical energy on a vessel according to an embodiment of the present invention.

The arrangement 200 has elements in common with the system 100 illustrated in FIG. 1 which are labeled with reference signs differing only in the first digit. A description of these elements can be taken from the description referring or associated with FIG. 1. The examples are given for the same ratings and consumer types as in FIG. 1, but as indicated above the specific voltage, battery capacity and types of essential consumers depend upon the application and are not limited to the values given in the examples.

A difference between the arrangements 100 and 200 is the assembly of several systems in one or several casings or switchboards. In FIG. 1, the transformer 133, the rectifier system 135, the inverter system 117 and the thrusters 123 are separated from the backup elements 103. The backup elements 103, including the battery 111, the DC-DC-converter 113 and also the elements 163, 165, 167 for powering auxiliary consumers 169 may for example be assembled into one casing or switchboard.

By contrast, in the arrangement 200 illustrated in FIG. 2, the transformer 233, the rectifier system 235 and the inverter system 217 are assembled together with the battery 211, the DC-DC-inverter 213 and also with the elements 263, 265, 267 together in one casing 271. The thrusters 223 and also the auxiliary AC-consumers 269 may be arranged outside the casing 271 and may be connectable thereto using appropriate sockets, plugs and cabling.

As in the arrangement 100 illustrated in FIG. 1, the DC-circuit 201 comprising the DC cable sections 205 is also configured in a ring harboring the backup elements 203 which may be disconnected by operating the breaker systems 207. When the breaker systems 207 disconnect a failed backup system, no interference with the main power grid 225 or 243 is present. The rectifier diodes 236 block power flowing back to the main grid 225, 243. The breaker systems 207 comprising breaker units 209 may disconnect the backup element 203, 257 in a very fast manner, such as within 10 to 20 μs. The batteries 211 may be arranged in the same fire zone as the auxiliary consumers, such as different thrusters 269. Thereby, high security and high reliability of the operation of the vessel may be achieved.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1. A stored electric energy distribution arrangement for distribution of stored electric energy on a vessel, the vessel comprising one or more AC consumers, in the event of failure, or insufficiency, of a primary electric energy supply to the AC consumers, the arrangement comprising:
a DC-circuit comprising a plurality of backup electric energy storage elements connected in a ring, for supplying stored electric energy to one or more AC consumers in the event of failure of the primary electric energy supply; and
a plurality of breaker systems in the DC circuit for disconnecting one or more backup electric energy storage elements from the DC-circuit, in the event of a fault associated with that backup element.

2. The stored electric energy distribution arrangement according to claim 1,
wherein the primary electric energy supply comprises an AC main grid.

3. An arrangement for distribution of electric energy on a vessel, comprising:
an AC main grid adapted to supply electric energy to one or more AC consumers in normal operation;
a DC-circuit comprising a plurality of electric energy storage backup elements connected in a ring, for supplying electric energy to the one or more AC consumers in the event of failure of the main grid; and
a plurality of breaker systems in the DC circuit for disconnecting one or more backup elements from the DC-circuit, in the event of a fault associated with that backup element.

4. The arrangement according to claim 1,
wherein at least one breaker system comprises two breaker units connected on each side of a backup element connected within the DC-circuit.

5. The arrangement according to claim 4,
wherein the breaker unit is adapted to, upon detection of a failure, disrupt, or break a connection to the DC-circuit in a time of between 5 μs and 500 μs,

6. The arrangement according to claim 5,
wherein the connection is disrupted or broken in a time of between 10 μs and 100 μs,

7. The arrangement according to claim 5,
wherein the connection is disrupted or broken in a time of between 10 μs and 20 μs.

8. The arrangement according to claim 4,
wherein the breaker unit is adapted to detect a failure by measurement of current and/or voltage on each side at a frequency of between 50 kHz and 500 kHz,

9. The arrangement according to claim 8,
wherein the measurement is at a rate of between 150 kHz and 250 kHz.

10. The arrangement according to claim 4,
wherein the breaker unit is adapted to disrupt, or break a connection to the DC-circuit, if the current measured on at least one side is larger than a current threshold and/or if a voltage difference measured on both sides is larger than a voltage difference threshold.

11. The arrangement according to claim 1,
wherein each of the backup elements comprises an energy storage unit, for storing electric energy for use in a failure situation.

12. The arrangement according to claim 11,
wherein the energy storage unit comprises a battery.

13. The arrangement according to claim 11,
wherein the energy storage unit is connected to the DC-circuit via a DC-DC-converter adapted to control input and output current and/or input and output voltage using pulse width modulation.

14. The arrangement according to claim 1,
wherein an AC-consumer is connectable to the DC-circuit via an inverter system.

15. The arrangement according to claim 1
wherein the AC consumer comprises one or more of a variable speed drive, a thruster, or auxiliary equipment.

16. The arrangement according to claim 15,
wherein the thruster receives energy from the DC-circuit via four inverters of the inverter system.

17. The arrangement according to claim 1, further comprising:
an AC-bar, having plural generators connected thereto.

18. The arrangement according to claim 17,
wherein the AC-bar is connectable to at least one other AC-bar to form an AC-ring.

19. The arrangement according to claim 17,
wherein the AC-bar, is connectable to at least one of the backup elements via a transformer, a diode and a rectifier system, wherein the diode is adapted to block an energy stream from the DC-circuit to the AC-bar.

20. The arrangement according to claim 19,
wherein the AC-bar operates at a voltage of between 5 kV and 15 kV.

21. The arrangement according to claim 19,
wherein the transformer transforms to a voltage of between 500 V and 1000 V.

22. The arrangement according to claim 19,
wherein the transformer has one set of primary windings and two sets of secondary windings,
wherein the rectifier system comprises two rectifiers connected to the two sets of secondary windings of the transformer.

23. The arrangement according to claim 19,
wherein the transformer and the rectifier system are separated from the backup element and housed in different casings.

24. The arrangement according to claim 19,
wherein the transformer, is housed together with the backup element in one casing.

25. A method for operating a stored electrical energy distribution arrangement for distribution of electric energy on a vessel comprising one or more AC consumers, the method comprising:
detecting a failure in a DC-circuit having a plurality of backup electrical energy storage elements connected in a ring for supplying stored electrical energy to the one or more AC consumers in the event of failure of the primary electric energy supply; and
disconnecting one of the backup elements from the DC-circuit using a plurality of breaker systems, in the event of a fault associated with that backup element.
